(19) United States
(12) Patent Application Publication
(10) Pub. No.: US 2013/0263512 A1
(43) Pub. Date: Oct. 10, 2013

(54) MOTOR VEHICLE DOOR WITH INTEGRATED DISPLAY MONITOR

(71) Applicant: JOHN A. HUS, STERLING, VA (US)

(72) Inventor: JOHN A. HUS, STERLING, VA (US)

(21) Appl. No.: 13/442,605

(22) Filed: Apr. 9, 2012

(51) Int. Cl. B60J 5/06; B60R 11/00; G09F 21/04

(52) U.S. Cl. 49/70

(57) ABSTRACT

Disclosed is a motor vehicle door with an integrated electronic display device. According to one example, the vehicle door may include a door frame that includes a window, and a mounting bracket affixed to the door frame over an area of the window by a number of bolts. The mounting bracket may have a number of bolt hole passages for the various bolts to pass through, and a vibration dampening pad contiguous with the mounting bracket and the electronic display device. The electronic display device may be turned on and configured to display various product advertisements and other information to persons viewing the display device from the outside of the motor vehicle.

### TECHNICAL FIELD OF THE INVENTION

The present invention is generally related to a motor vehicle door that includes an integrated display monitor viewable by persons observing the exterior of the vehicle.

### BACKGROUND OF THE INVENTION

Commercial vehicle advertisements and information are displayed on the exterior of vehicles for persons to observe. The purpose may be to advertise a service or product while maximizing the space on the body of the commercial vehicle.

With the advancements in flat panel display devices (e.g., computer monitors, televisions etc.), the price and size of such devices has become increasingly popular for purposes beyond use in the home or office. For example, displays are being mounted above gas pumps, in stores, at restaurants and even elevators to provide information about products or services. However, most commercial vehicles are not equipped to power, house and/or safely hold a display monitor without jeopardizing the safety of the device. As a result, the motor vehicle still fails to meet the growing trend of integrating display devices for outdoor advertising purposes.

### SUMMARY OF THE INVENTION

One example embodiment of the present invention may include a motor vehicle door with an integrated electronic display device. The vehicle door may include a door frame that has a window, and a mounting bracket affixed to the door frame over an area of the window via a plurality of bolts. The mounting bracket may include a plurality of bolt hole passages for the plurality of bolts to pass through, and a vibration dampening pad contiguous with the mounting bracket and the electronic display device.

### BRIEF DESCRIPTION OF THE DRAWINGS

FIG. 1 illustrates a mobile vehicle including an integrated electronic display device according to example embodiments.

FIG. 2 illustrates a mobile vehicle including an integrated electronic display device with the door in the opened position according to example embodiments.

FIG. 3 illustrates a view of the electronic display device mounted on the door frame behind a vehicle door window according to example embodiments.

FIG. 4 illustrates an exploded view of the components of the integrated door and electronic display device according to example embodiments.

### DETAILED DESCRIPTION

It will be readily understood that the components of the present invention, as generally described and illustrated in the figures herein, may be arranged and designed in a wide variety of different configurations. Thus, the following detailed description of the embodiments of an apparatus, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

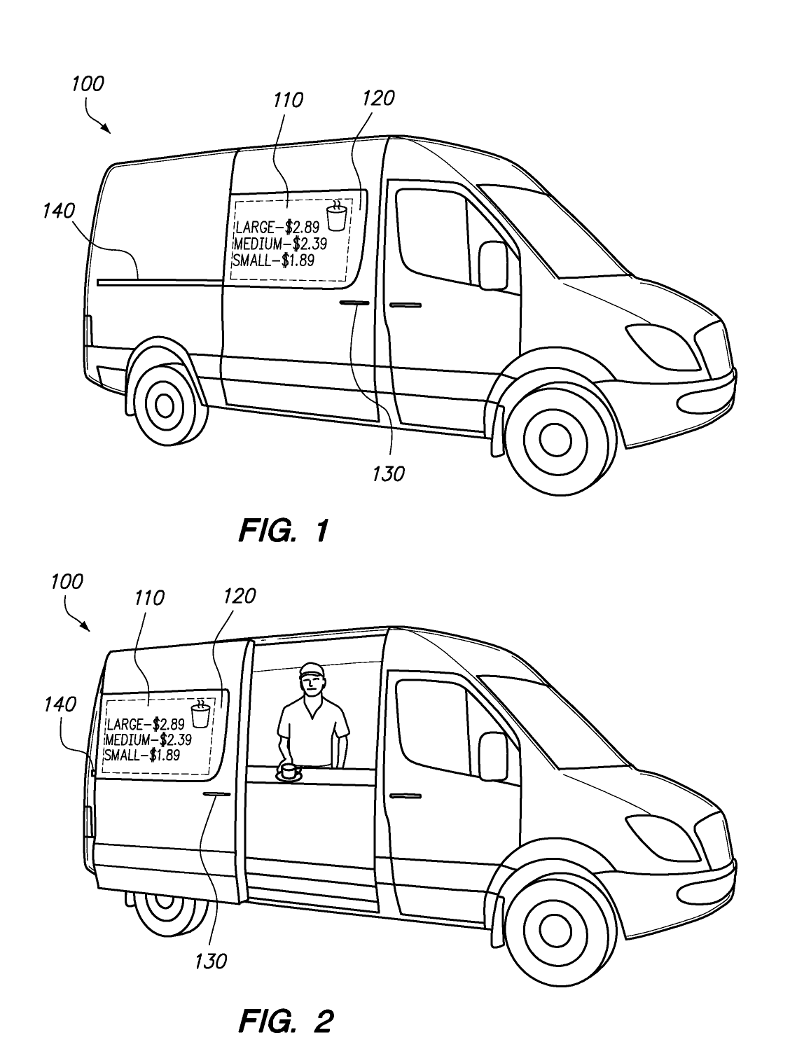

FIG. 1 illustrates a mobile vehicle including an integrated electronic display device according to example embodiments. Referring to FIG. 1, a mobile vehicle or motor vehicle 100 is illustrated as being a food/beverage service vehicle. Those skilled in art would appreciate that the vehicle could be a car, truck, van, bus, boat, train or even air vehicle. The vehicle 100 includes a door 130 with a door handle used to open and close the door. In this example, the door 130 has a window 120 that is flush with the exterior door surface. The electronic display device 110 is mounted inside the vehicle 100 behind the exterior window surface 120.

The door 130 may be opened via the door handle and moved parallel to the side wall of the vehicle 100 on a door sliding track 140. The door may be automatically opened via a remote control radio frequency (RF) signal that initiates a battery powered motor to initiate de-latching of the door handle and a sliding motion that moves the door down the track 140. In operation, the display device 110 may be powered on and provide an electronic display of menu items, advertising and other pre-programmed information (local weather, news, etc.).

In the example of FIG. 2, the display device 110 may be powered on and to display menu items (i.e., coffee prices) to viewers outside the vehicle. Referring to FIG. 2, as a customer approaches, the operator may initiate the opening of the door which exposes the ordering counter providing the customer (not shown) with an opportunity to approach the vehicle and order food and beverages, etc. The vehicle may have a motion and/or audio sensor used to detect an approaching customer. The motion sensor may initiate the door opening automatically via a microprocessor and/or controller device. The sensor(s) may be part of the door (not shown) and may be facing the external side view of the motor vehicle to detect movement, sound, etc.

The sensor detecting motion and or sound may also initiate the displaying of a series of advertisements configured to offer a certain number of menu items over a predefined time interval. The advertisement lineup may be stored in memory and retrieved responsive to a triggered event, such as the detected movement of an approaching customer. The advertisement lineup may include an array of different photos, audio and/or video content that is initiated the moment one or more of the sensors is triggered. The content may be stored in memory either locally in the display device or remotely via a datastore or computer in communication with the display device (i.e., wireless communication, 3G, WIFI, etc.).

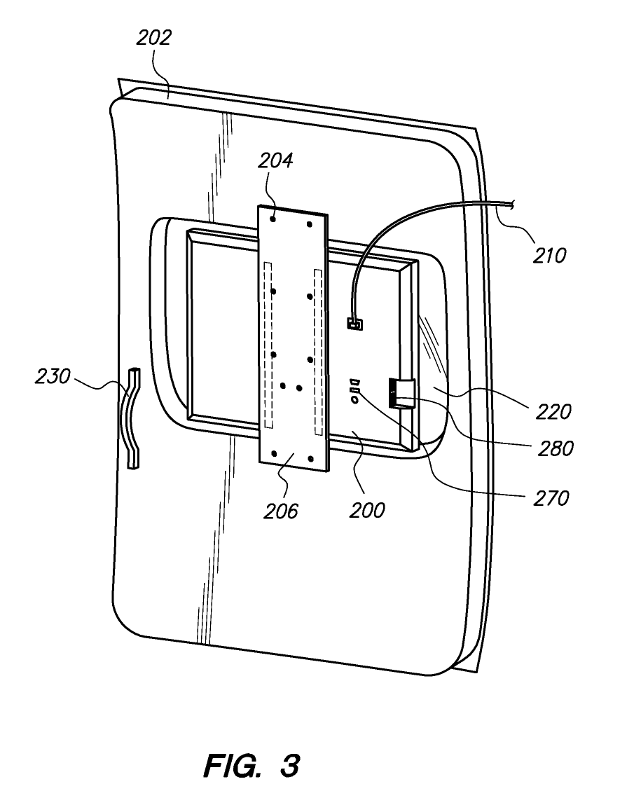

FIG. 3 illustrates a view of the electronic display device mounted on the door frame behind a vehicle door window according to example embodiments. Referring to FIG. 3, a door 202 is illustrated from the perspective of the inside of a motor vehicle. The door may be moved into an open position via a door handle 230 or via an internal motor not shown. The door includes various components that enable an electronic display to be properly mounted for offering advertisements and other information to viewers on the outside of the vehicle. For example, a mounting plate 206 is illustrated as being mounted onto the door frame via a series of screws or bolts. In this example, four bolts 204 are used to mount the plate 204 to the door frame 202, however, any reasonable number of bolts may be used (2, 4, 6, 8 or more).

The display device 200 includes a series of bolt holes that may be prefabricated into the rear portion of the display device, or which may be drilled and inserted with a corresponding bolt hole thread for receiving a bolt. The display device 200 may be an electronic monitor or television and may be a liquid crystal display (LCD) display device, a light emitting diode (LED) display device, a plasma display device, etc.

Additionally, the display device 200 may include various different signal interfaces 270 including but not limited to an HDMI input interface, a RCA input interface, a S-Video interface a firewire interface, a serial data interface, a coax interface, and a PCI computer interface, etc. Also, the display device 200 may include a memory slot 280 which provides an interface for a random access memory card or chip to be inserted into the display device and provide content to be displayed on the display device 200. A power cord 210 is illustrated as being connected to a power interface on the display device 200. A power generator may be integrated into a floor panel of the vehicle to generate power while the vehicle is powered off. The power may be used to drive the display device 200 via its power cable 210.

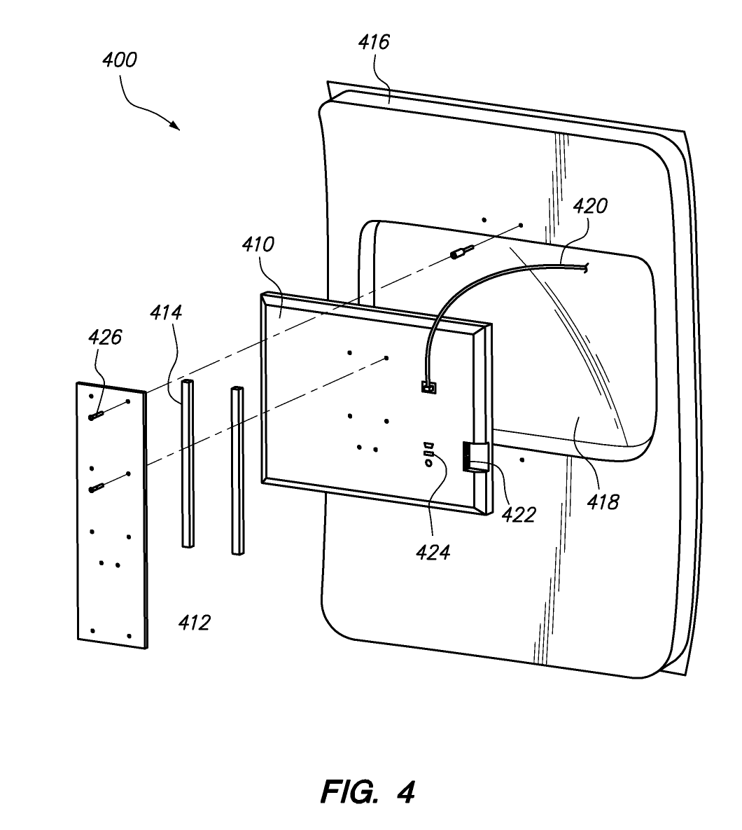

FIG. 4 illustrates an exploded view 400 of the components of the integrated door and electronic display device according to example embodiments. Referring to FIG. 4, like components in FIG. 3 may be referred to synonymously in FIG. 4. The mounting plate is illustrated as a first layer being mounted to the display device 410 and the door frame 416. The bolts 426 may include different types of bolts or the same type of bolts. For example, the bolts 426 used to mount the mounting plate 412 to the door frame 416 may be Molly bolts which have a receiving end or Molly fastener that is affixed to the door frame 416. The bolts 426 may then be placed through the pre-drilled holes in the mounting plate and into the door frame Molly fastener configuration.

Generally, the first step would be to mount the display device 410 to the mounting plate 412. As illustrated in FIG. 4, the array of holes on the display device 410 may be used to receive the bolts 426 through the mounting plate 412 prior to affixing the mounting plate to the door frame 416. Soft and/or flexible material 414 may be used to create a vibration dampening effect that provides safety and protection for the display device while the vehicle is being operated. Additionally, the bolts may be inserted into plastic or rubber washers (not shown) prior to tightening the bolts into the display device 410 or the door 416. The display device 410 may also include a series of interfaces 424 and a memory interface 422 used to provide content to the display device. The playing function that initiates the display of the content may be provided by a remote control or other wireless signal. The signal used to initiate the display of the content may be provided from a remote device and as a result of a triggered sensor as described above with reference to FIGS. 1 and 2.

The display device may be mounted directly behind the vehicle door window 418 to protect the device from outdoor weather conditions, theft and vandalism. The power cord 420 may be sufficiently long to allow the door to be moved along the door track while providing continues power to the display device 410. The mounting plate may be composed of a diamond plated aluminum that is ⅛, ¼ or ½ inch thick, although ¼ inch thick was tested and is sufficiently rigid enough to support the display device. The vibration dampeners may be placed between the display device and the mounting plate in two, four or more rows that lay parallel to the length of the mounting plate. A 42 inch LED display device that was between 1-2 inches thick was tested and found to be sufficiently thin enough to be mounted between the mounting bracket and the window. However, if the display device is larger, such as a LED monitor, then a square-edged “C” shaped mounting bracket may be used where the ends of the mounting bracket extend forward ⅛, ¼ or ½ inch to allow the display device to be recessed from the position where the mounting bracket is mounted on the door frame.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A motor vehicle door with an integrated electronic display device, the vehicle door comprising:
a door frame comprising
a window, and
a mounting bracket affixed to the door frame over an area of the window via a plurality of bolts, the mounting bracket comprising
a plurality of bolt hole passages for the plurality of bolts to pass through, and
a vibration dampening pad contiguous with the mounting bracket and the electronic display device.

2. The motor vehicle door of claim 1, wherein the bolts are Molly bolts.

3. The motor vehicle door of claim 1, wherein the mounting bracket is comprised of diamond plated aluminum.

4. The motor vehicle door of claim 3, wherein the mounting bracket is ¼ inch diamond plated aluminum.

5. The motor vehicle door of claim 3, wherein the plurality of bolt hole passages comprise at least four bolt hole passages that are contiguous with the electronic display device and which hold a corresponding set of at least four bolts which are engaged into the electronic display device.

6. The motor vehicle door of claim 5, wherein the plurality of bolt hole passages further comprise at least four additional bolt hole passages that are contiguous with the door frame and which hold a corresponding set of four bolts which are engaged into the door frame via a Molly bolt and Molly fastener configuration.
